(19) United States
(12) Patent Application Publication
(10) Pub. No.: US 2017/0112285 A1
(43) Pub. Date: Apr. 27, 2017

(54) Occupational Therapy Assembly

(71) Applicant: Yekaterina Magras, Staten Island, NY (US)

(72) Inventor: Yekaterina Magras, Staten Island, NY (US)

(21) Appl. No.: 14/923,530

(22) Filed: Oct. 27, 2015

(51) Int. Cl. A47C 1/00; G09B 19/00; A47D 1/00; A47C 3/40; A47C 3/34

(52) U.S. Cl. CPC A47C 1/00; A47C 3/40; A47C 3/34; A47D 1/004; G09B 19/003

(57) ABSTRACT

An occupational therapy assembly includes a sitting unit that has a first chair portion and a second chair portion. The first chair portion may have a first user sit thereon. The second chair portion may have a second user sit thereon. The second chair portion is positioned above and behind the first chair portion. Thus, the second chair portion facilitates the second user to view activities performed by the first user. The second chair additionally facilitates the second user to perform occupational therapy with the first user. A plurality of legs is provided and each of the legs is movably coupled to the sitting unit. Each of the legs may abut a support surface.

### BACKGROUND OF THE DISCLOSURE

### Field of the Disclosure

The disclosure relates to occupational therapy devices and more particularly pertains to a new occupational therapy device for facilitating a second user to sit above and behind a first user.

### SUMMARY OF THE DISCLOSURE

An embodiment of the disclosure meets the needs presented above by generally comprising a sitting unit that has a first chair portion and a second chair portion. The first chair portion may have a first user sit thereon. The second chair portion may have a second user sit thereon. The second chair portion is positioned above and behind the first chair portion. Thus, the second chair portion facilitates the second user to view activities performed by the first user. The second chair additionally facilitates the second user to perform occupational therapy with the first user. A plurality of legs is provided and each of the legs is movably coupled to the sitting unit. Each of the legs may abut a support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of an occupational therapy assembly according to an embodiment of the disclosure.

FIG. 2 is a front view of an embodiment of the disclosure.

FIG. 3 is a top view of an embodiment of the disclosure.

FIG. 4 is a right side view of an embodiment of the disclosure.

FIG. 5 is a perspective in-use view of an embodiment of the disclosure.

### DESCRIPTION OF THE PREFERRED EMBODIMENT

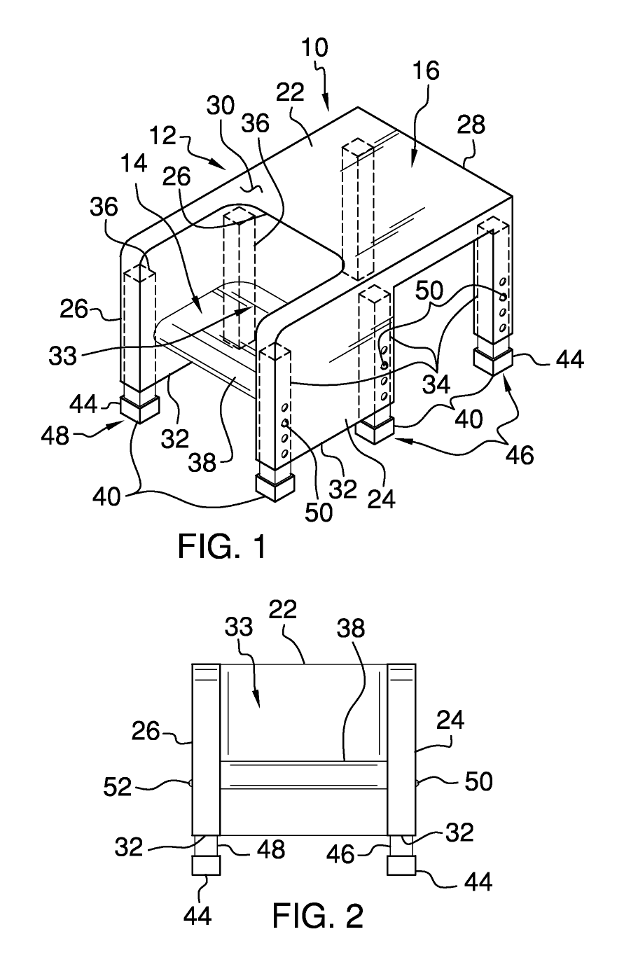

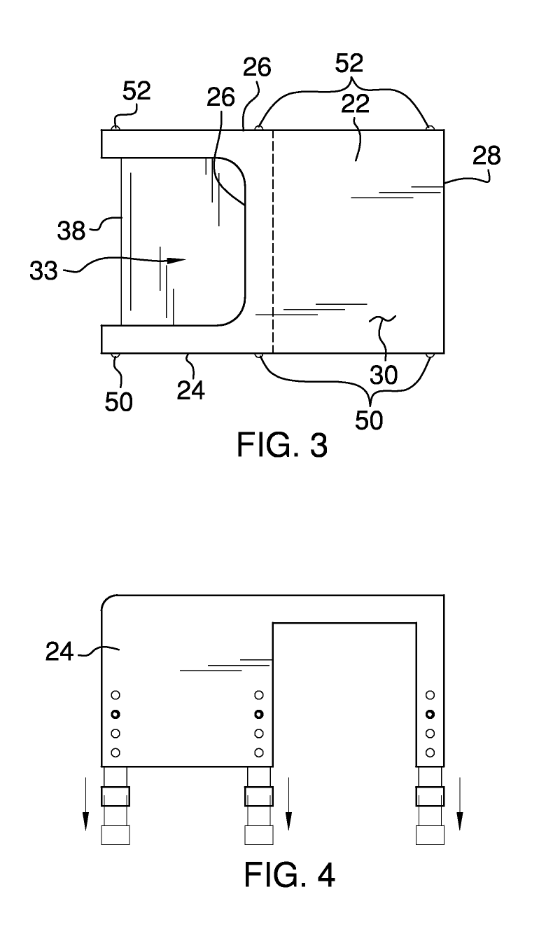

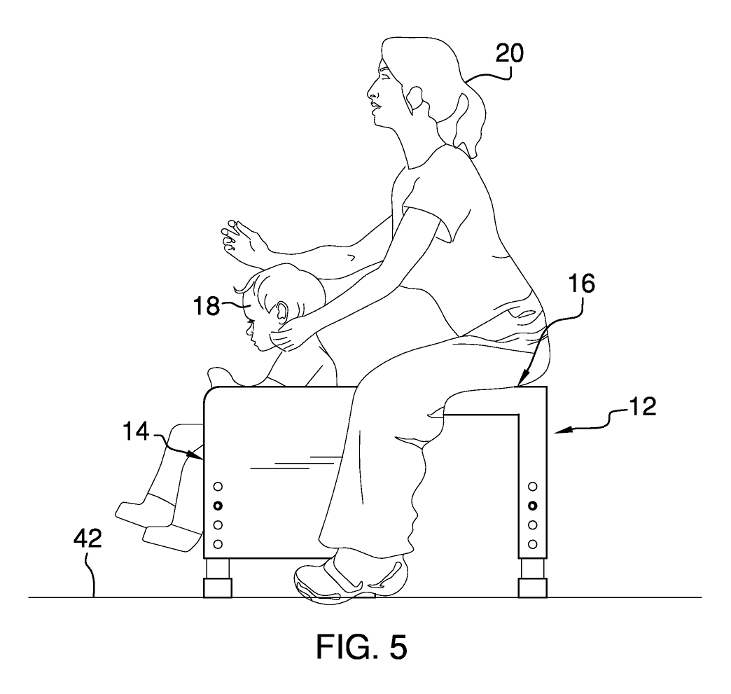

With reference now to the drawings, and in particular to FIGS. 1 through 5 thereof, a new occupational therapy device embodying the principles and concepts of an embodiment of the disclosure and generally designated by the reference numeral 10 will be described.

As best illustrated in FIGS. 1 through 5, the occupational therapy assembly 10 generally comprises a sitting unit 12 that has a first chair portion 14 and a second chair portion 16. The first chair portion 14 may have a first user 18 sit thereon and the second chair portion 16 may have a second user 20 sit thereon. The second chair portion 16 is oriented above and behind the first chair portion 14. Thus, the second chair portion 16 facilitates the second user 20 to view activities performed by the first user 18. Additionally, the second chair portion 16 facilitates the second user 20 to perform occupational therapy with the first user 18. The second user 20 may be an occupational therapist and the first user 18 may be a special needs child.

The sitting unit 12 has a top wall 22, a first lateral wall 24 and a second lateral wall 26. The top wall 22 has a front side 26, a back side 28 and a top surface 30. The top surface 30 defines the second chair portion 16. Each of the first lateral wall 24 and the second lateral wall 26 extend downwardly from the top wall 22. Each of the first lateral wall 24 and the second lateral wall 26 are spaced apart from each other and each of the first lateral wall 24 and the second lateral wall 26 has a distal edge 32 with respect to the top wall 22.

Each of the first lateral wall 24 and the second lateral wall 26 extend forwardly from the front side 26 to define a space 33 between the first lateral wall 24 and the second lateral wall 26. The distal edge 32 of the first lateral wall 24 has a plurality of first wells 34 extending upwardly therein. The first wells 34 are spaced apart from each other and distributed along the first lateral wall 24. The distal edge 32 of the second lateral wall 26 has a plurality of second wells 36 extending upwardly therein. The second wells 36 are spaced apart from each other and distributed along the second lateral wall 26. Each of the first lateral wall 24 and the second lateral wall 26 may be open between the front side 26 of the top wall 22 and a point that is closer to the back side 28 of the top wall 22 than the front side 26.

A seat 38 is coupled between the first lateral wall 24 and the second lateral wall 26. The seat 38 is positioned within the space 33. The seat 38 defines the first chair portion 14. The seat 38 is centrally positioned between the top surface 30 of the top wall 22 and the distal edge 32 of each of the first lateral wall 24 and the second lateral wall 26.

A plurality of legs 40 is provided and each of the legs 40 is movably coupled to the sitting unit 12. Each of the legs 40 may abut a support surface 42 and the support surface 42 may comprise a floor or the like. Each of the plurality of legs 40 includes a foot 44 and the foot 44 abuts the support surface 42 to support the sitting unit 12 above the support surface 42. The plurality of legs 40 comprises a first set of legs 46 and a second set of legs 48. Each of the first set of legs 46 is slidably positioned within an associated one of the first wells 34. Each of the second set of legs 48 is slidably positioned within an associated one of the second wells 36.

A plurality of first locks 50 is provided and each of the first locks 50 is movably coupled to an associated one of the first set of legs 46. Each of the first locks 50 engages the first lateral wall 24 at a selected point such that each of the first set of legs 46 is retained at a selected height. A plurality of second locks 52 is provided and each of the second locks 52 is movably coupled to an associated one of the second set of legs 48. Each of the second locks 52 engages the second lateral wall 26 at a selected point such that each of the second set of legs 48 is retained at a selected height.

In use, each of the first set of legs 46 and the second set of legs 48 are positioned at the selected height. The first user 18 is seated on the first chair portion 14 and the second user 20 is seated on the second chair portion 16. The first user 18 engages in an activity associated with occupational therapy. The second user 20 observes the activity and the second user 20 provides physical assistance if necessary. The second chair portion 16 orients the second user 20 above the first user 18. Thus, the second chair portion 16 facilitates the second user 20 to remain in an upright seated position while the second user 20 observes the activity. The second chair portion 16 orients the second user 20 behind the first user 18. Thus, the second chair portion 16 facilitates the second user 20 to provide occupational therapy. Additionally, the second chair portion 16 reduces strain on the second user's lower back while the second user 20 provides occupational therapy.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An occupational therapy assembly comprising:
a sitting unit having a first chair portion and a second chair portion, said first chair portion being configured to have a first user sit thereon, said second chair portion being configured to have a second user sit thereon, said second chair portion being positioned above and behind said first chair portion wherein said second chair portion is configured to facilitate the second user to view activities performed by the first user and to facilitate the second user to perform occupational therapy with the first user; and
a plurality of legs, each of said legs being movably coupled to said sitting unit wherein each of said legs is configured to abut a support surface.

2. The assembly according to claim 1, wherein said sitting unit has a top wall, a first lateral wall and a second lateral wall, said top wall having a front side and a top surface, said top surface defining said second chair portion.

3. The assembly according to claim 2, wherein each of said first lateral wall and said second lateral wall extends downwardly from said top wall, each of said first lateral wall and said second lateral wall being spaced apart from each other, each of said first lateral wall and said second lateral wall having a distal edge with respect to said top wall, each of said first lateral wall and said second lateral wall extending forwardly from said front side to define a space between said first lateral wall and said second lateral wall.

4. The assembly according to claim 3, wherein said distal edge of said first lateral wall has a plurality of first wells extending upwardly therein, said first wells being spaced apart from each other and distributed along said first lateral wall.

5. The assembly according to claim 3, wherein said distal edge of said second lateral wall has a plurality of second wells extending upwardly therein, said second wells being spaced apart from each other and distributed along said second lateral wall.

6. The assembly according to claim 1, further comprising:
a first lateral wall and a second lateral wall being spaced apart from each other to define a space; and
a seat being coupled between said first lateral wall and said second lateral wall, said seat being positioned within said space such that said seat defines said first chair portion.

7. The assembly according to claim 6, wherein:
said sitting unit has a top wall, said top wall having a top surface;
each of said first lateral wall and said second lateral wall having a distal edge with respect to said top wall; and
said seat is centrally positioned between said top surface of said top wall and said distal edge of said first lateral wall and said distal edge of said second lateral wall.

8. The assembly according to claim 1, wherein:
said sitting unit has a plurality of first wells and a plurality of second wells; and
each of said plurality of legs includes a foot, said foot being configured to abut the support surface such that said sitting unit is support above the support surface, said plurality of legs comprising a first set of legs and a second set of legs, each of said first set of legs being slidably positioned within an associated one of said first wells, each of said second set of legs being slidably positioned within an associated one of said second wells.

9. The assembly according to claim 8, further comprising a plurality of first locks, each of said first locks being movably coupled to an associated one of said first set of legs, each of said first locks engaging said first lateral wall at a selected point such that each of said first set of legs is retained at a selected height.

10. The assembly according to claim 8, further comprising a plurality of second locks, each of said second locks being movably coupled to an associated one of said second legs, each of said second locks engaging said second lateral wall at a selected point such that each of said second legs is retained at a selected height.

11. An occupational therapy assembly comprising:
a sitting unit having a first chair portion and a second chair portion, said first chair portion being configured to have a first user sit thereon, said second chair portion being configured to have a second user sit thereon, said second chair portion being positioned above and behind said first chair portion wherein said second chair portion is configured to facilitate the second user to view activities performed by the first user and to facilitate the second user to perform occupational therapy with the first user, said sitting unit having a top wall, a first lateral wall and a second lateral wall, said top wall having a front side a top surface, said top surface defining said second chair portion, each of said first lateral wall and said second lateral wall extending downwardly from said top wall, each of said first lateral wall and said second lateral wall being spaced apart from each other, each of said first lateral wall and said second lateral wall having a distal edge with respect to said top wall, each of said first lateral wall and said second lateral wall extending forwardly from said front side to define a space between said first lateral wall and said second lateral wall, said distal edge of said first lateral wall having a plurality of first wells extending upwardly therein, said first wells being spaced apart from each other and distributed along said first lateral wall, said distal edge of said second lateral wall having a plurality of second wells extending upwardly therein, said second wells being spaced apart from each other and distributed along said second lateral wall;
a seat being coupled between said first lateral wall and said second lateral wall, said seat being positioned within said space such that said seat defines said first chair portion, said seat being centrally positioned between said top surface of said top wall and said distal edge of said first lateral wall and said distal edge of said second lateral wall;
a plurality of legs, each of said legs being movably coupled to said sitting unit wherein each of said legs is configured to abut a support surface, each of said plurality of legs including a foot, said foot being configured to abut the support surface such that said sitting unit is support above the support surface, said plurality of legs comprising a first set of legs and a second set of legs, each of said first set of legs being slidably positioned within an associated one of said first wells, each of said second set of legs being slidably positioned within an associated one of said second wells;
a plurality of first locks, each of said first locks being movably coupled to an associated one of said first set of legs, each of said first locks engaging said first lateral wall at a selected point such that each of said first set of legs is retained at a selected height; and
a plurality of second locks, each of said second locks being movably coupled to an associated one of said second set of legs, each of said second locks engaging said second lateral wall at a selected point such that each of said second set of legs is retained at a selected height.
